(19) United States
(12) Patent Application Publication
(10) Pub. No.: US 2024/0292095 A1
(43) Pub. Date: Aug. 29, 2024

(54) REDUCED POWER CAMERA CONTROL SYSTEM

(71) Applicant: Intel Corporation, Santa Clara, CA (US)

(72) Inventors: Wei Hu, Shanghai 31 (CN); Kaijia Zhu, Beijing 11 (CN); Yu Xia, Beijing 11 (CN); Fuwen Li, Beijing (CN); Hongjiang Zheng, Bejing (CN)

(73) Assignee: Intel Corporation, Santa Clara, CA (US)

(21) Appl. No.: 18/573,572

(22) PCT Filed: Dec. 14, 2021
(86) PCT No.: PCT/CN2021/137723

§ 371 Date: Dec. 22, 2023

(51) Int. Cl. H04N 23/65; G06T 1/00; G06T 7/254

(52) U.S. Cl. CPC H04N 23/651; G06T 1/0007; G06T 7/254; G06T 2207/10016; G06T 2207/30232

(57) ABSTRACT

Techniques are provided for a camera control system with reduced power consumption. A system implementing the techniques according to an embodiment includes a scene change tracker configured to quantify a level of change between current and previous image frames provided by the camera. The system also includes a general purpose processor to generate camera control parameters using a first processing algorithm, based on the current and previous image frames, if the level of change exceeds a threshold. The system further includes an image signal processor to generate the camera control parameters using a second processing algorithm, based on the current and previous image frames, if the level of change is less than or equal to the threshold. The image signal processor consumes less power than the general purpose processor and the second processing algorithm is less computationally complex than the first processing algorithm.

### BACKGROUND

Digital cameras play an important role in modern computing and communication devices, particularly as online video conferencing and collaboration becomes more ubiquitous. In teleconferencing applications, cameras may now be required to operate continuously for many hours as meetings can often be scheduled back to back. This usage scenario poses a challenge to battery powered devices (e.g., mobile devices such as laptops and smartphones) since camera operation can consume a significant portion of the power budget for these devices.

### BRIEF DESCRIPTION OF THE DRAWINGS

FIG. 1 illustrates a camera control system, configured in accordance with an embodiment of the present disclosure.

FIG. 2 is a block diagram of the camera control system of FIG. 1, configured in accordance with an embodiment of the present disclosure.

FIG. 3 is a block diagram of the camera control system of FIG. 1, configured in accordance with another embodiment of the present disclosure.

FIG. 4 is a flowchart illustrating a camera control process flow, in accordance with an embodiment of the present disclosure.

FIG. 5 is a flowchart illustrating a methodology for camera control, in accordance with an embodiment of the present disclosure.

FIG. 6 is a block diagram schematically illustrating a computing platform configured to perform camera control, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided for a camera control system with reduced power consumption. As previously noted, digital cameras are becoming increasingly important as teleconferencing applications for online video conferencing and collaboration are being adopted into widespread use. As such, cameras may now be required to operate continuously for many hours. This can pose a challenge for battery powered devices (e.g., mobile devices such as laptops and smartphones) since camera operation, including the generation and update of camera control parameters, can consume a significant portion of the power budget for these devices.

To this end, techniques are provided herein for the generation and update of camera control parameters including auto-focus, auto-exposure, auto-whitebalance, and video stabilization parameters, etc., with improved power efficiency. According to one such embodiment, the workload associated with generating these parameters is shifted, whenever possible, from a relatively high power consuming general purpose processor or central processing unit (CPU) executing a relatively complex algorithm, to a lower power consuming image signal processor (ISP) executing a simplified algorithm, as will be explained in greater detail. The decision as to whether such a shift can be made for any given image frame is based on an analysis of the level of scene change between images frames, as will also be described in greater detail below.

The disclosed techniques can be implemented, for example, in a computing system or a software product executable or otherwise controllable by such systems, although other embodiments will be apparent. The system or product is configured to reduce the power consumption associated with the generation of camera control parameters, for example by allowing the CPU to spend more time in a power conserving sleep state. In accordance with such an embodiment, a system to implement these techniques includes a scene change tracker configured to quantify a level of scene change between current and previous image frames provided by the camera. The system also includes a CPU to generate camera control parameters, based on the current and/or previous image frames, using a first processing algorithm, if the quantified level of scene change exceeds a threshold (e.g., if the scene change is relatively large). The system further includes an ISP to generate the camera control parameters using a second (e.g., alternative) processing algorithm, if the level of scene change does not exceed the threshold. The ISP processing can be performed by any combination of hardware, software, and firmware. In some embodiments, the second processing algorithm is a lower complexity version of the first algorithm, which can, however, provide results of sufficient quality, if the level of scene change between the image frames is relatively small (e.g., based on the threshold). In many camera applications, such as video conferencing, there may be minimal scene change between image frames, and complex processing is not always needed to generate the camera control parameters.

Power reduction can be realized by shifting workload from the CPU to the ISP in this manner, whenever possible, allowing the CPU to enter a power conserving sleep state or other low power state, or remain in such a state for longer periods of time. Also, in some embodiments, additional power savings may be realized as the ISP may consume less power than the CPU, due in part to both the relatively simpler hardware of the ISP and the computationally simpler version of the algorithm executed by the ISP.

As will be appreciated, the techniques described herein may provide reduced power consumption for devices that operate cameras by shifting workload to the ISP when possible, compared to existing techniques that require the main CPU of the device to handle the full workload associated with generating camera control parameters. Since many video applications generate image frames at a rate of 30 frames per minute or more, existing techniques, that rely solely on the main CPU for control parameter generation, can significantly limit the ability of the CPU to enter low power or sleep states. The disclosed techniques can be implemented on a broad range of platforms including workstations, laptops, tablets, smartphones, automotive systems, robotic systems, and voice controlled systems, and are particularly valuable for mobile and battery operated devices. These techniques may further be implemented in hardware or software or a combination thereof.

### System Architecture

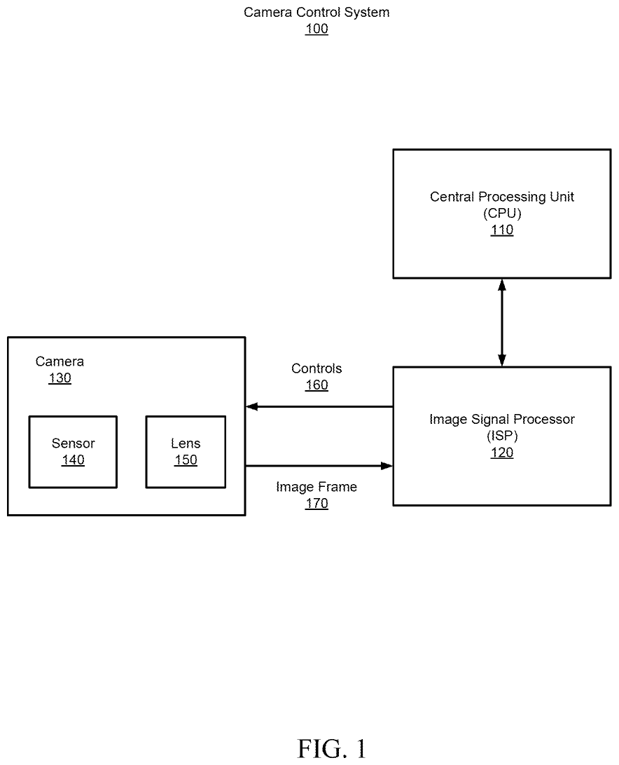

FIG. 1 illustrates a camera control system 100, configured in accordance with an embodiment of the present disclosure. The camera control system is shown to include a CPU 110, an ISP 120, and a camera to be controlled 130. The operation of the camera control system 100 will be described in greater detail below, but at a high level, the camera 130 provides image frames 170 to the ISP, and an analysis of these frames is performed by some combination of the ISP and the CPU to determine appropriate camera control parameters 160. In some embodiments, the ISP 120 may be incorporated in the camera 130.

The analysis algorithm is sometimes referred to as a “3A” algorithm to designate auto-focus, auto-exposure, auto-whitebalance. The algorithm may also be referred to as a “3A+” algorithm, a “4A” algorithm, a “5A” algorithm, or more generally as a camera control automation (CCA) algorithm, to cover other factors that may be controlled, such as video stabilization, etc. It will be appreciated that the techniques disclosed herein may be used to control any CCA factors. The parameters 160 are transmitted back to the camera to control the image sensor 140, lens 150, and any other relevant components of the camera. For example, an auto-focus parameter may be used to adjust the lens 150, an auto-exposure parameter may be used to adjust an aperture of the lens, white balance may be used to adjust the sensor, etc.

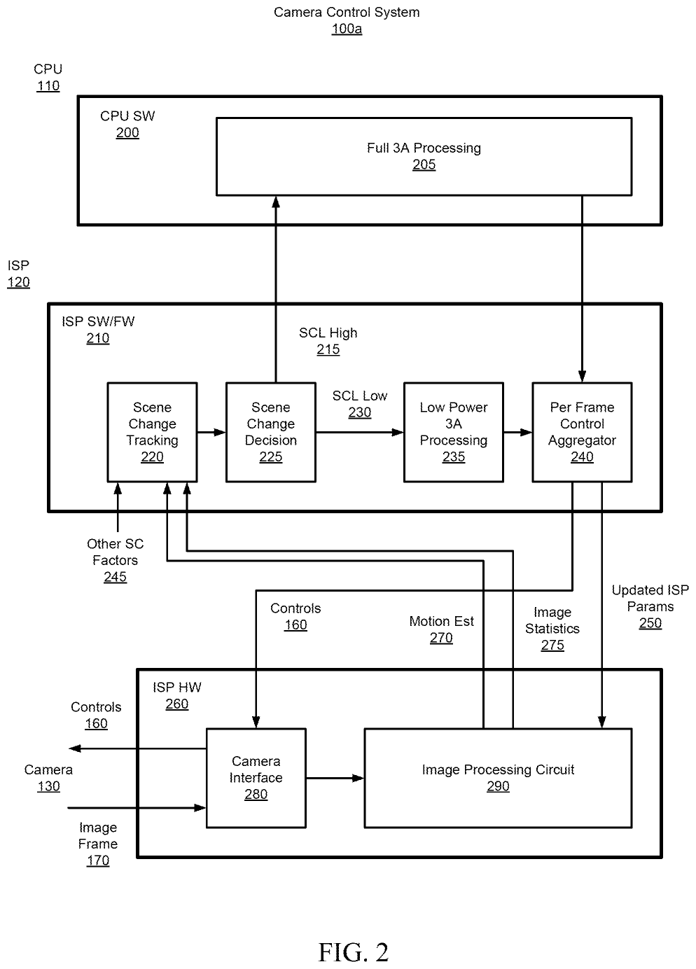

FIG. 2 is a block diagram of the camera control system of FIG. 1, configured in accordance with an embodiment 100a of the present disclosure. The camera control system 100a is shown to include CPU 110 which is configured to execute CPU software 200 that includes a full 3A processing algorithm 205. The camera control system 100a is shown to also include ISP 120 which further comprises scene change tracker 220, scene change decision module 225, low power 3A processing algorithm 235, control aggregator 240, camera interface 280, and image processing circuit 290. In this example, scene change tracker 220, scene change decision module 225, low power 3A processing algorithm 235, and control aggregator 240 are shown to be implemented in ISP software or firmware 210, while camera interface 280, and image processing circuit 290 are shown to be implemented in ISP hardware 260. It will be appreciated, however, that other configurations are possible.

Scene change tracker 220 is configured to quantify a level of scene change between current and previous image frames provided by the camera. The quantification of the level of change in the scene may be based on one or more factors. In some embodiments, one of these factors is an estimation of the motion of foreground and/or background elements in the image, since motion correlates with scene change. Motion estimation 270 may be performed and provided by the image processing circuit 290, using any suitable technique in light of the present disclosure. In some embodiments, other suitable image statistics 275 may be estimated by the image processing circuit 290, using line based and/or block based processing, and provided for use in scene change tracking. In some embodiments, another scene change factor 245 may include the detection of an appearance or disappearance of a face in the image. Any suitable facial detection technique may be used for this purpose, in light of the present disclosure.

In some embodiments, another factor 245 may include a measured time difference between acquisition of the current image frame and the previous image frame. For example, a longer elapsed time may be associated with a greater likelihood of scene change. In some embodiments, yet another factor 245 may include accelerometer data and/or gyroscope data provided by the camera. For example, rapid motions or changes in orientation of the camera are more likely associated with scene change.

The scene change decision module 225 is configured to compare the quantified level of scene change to a threshold value to decide whether the scene change level (SCL) is high 215 or low 230. For the case of a high SCL 215, full 3A processing 205 is performed by the CPU 110. For the case of a low SCL 230, low power 3A processing 235 is performed by the ISP 120 without requiring a wakeup of the CPU 110 from a low power state. In some embodiments, the threshold value may be chosen empirically or user configurable.

The full 3A processing algorithm 205 is configured to generate camera control parameters, based on the current and previous image frames, for the high SCL case 215. In some embodiments, the camera control parameters include auto-focus parameters, auto-exposure parameters, auto-whitebalance parameters, and video stabilization parameters. In some embodiments, the full 3A processing algorithm 205 is executed on CPU 110 and comprises a high complexity or “full” version of the algorithm which is more computationally complex than the low power 3A processing algorithm 235 described below. For example, in some embodiments, a high complexity version of an algorithm to compute auto-exposure parameters may include complex non-linear processing, or linear Kalman filtering predictive processing, applied to luminance statistics of the images, both of which can be computationally expensive and relatively high cost.

The low power 3A processing algorithm 235 is configured to generate the camera control parameters, based on the current and previous image frames, for the low SCL case 230. In some embodiments, the low power 3A processing algorithm 235 is executed on ISP 120 and comprises a lower complexity version of the algorithm compared to the full 3A processing algorithm 205 described above. For example, in some embodiments, a low power version of an algorithm to compute auto-exposure parameters may include linear interpolation applied to luminance statistics of the images, which is a relatively simple and low cost computation. As another example, a low power version of an algorithm to compute white balance parameters may run on a greyscale version of the image while a higher complexity version of the algorithm may run on the full color image.

The control aggregator 240 is configured to collect the parameters generated by either the full processing algorithm 205 or the low power algorithm 235 and provide them as updated ISP parameters 250, for use by the image processing circuit 290. The control aggregator 240 also provides the parameters as control values to be delivered to the camera 130 through the camera interface 280, so that the camera can control the sensor 140, lens 150, and other elements/components as needed.

The camera interface 280 is configured to communicate between the ISP 120 and the camera 130. In some embodiments, the camera interface may use an Inter-Integrated Circuit (I2C or I3C) communication bus, or a Mobile Industry Processor Interface (MIPI) camera serial interface.

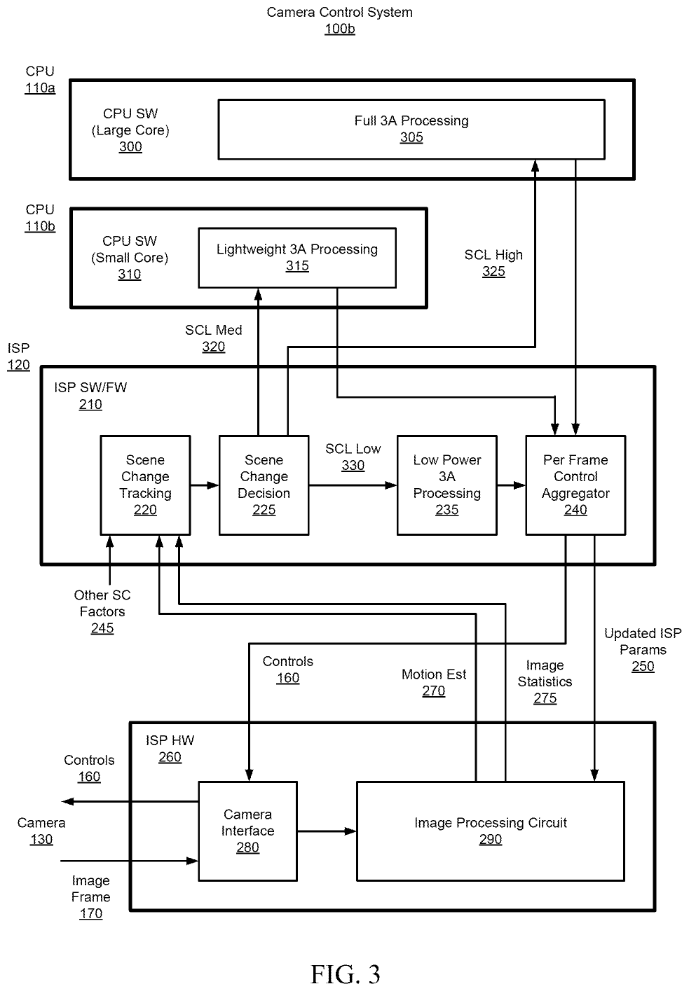

FIG. 3 is a block diagram of the camera control system of FIG. 1, configured in accordance with another embodiment 100b of the present disclosure. This embodiment is similar to the embodiment 100a described previously, except that the CPU 110 comprises two CPUs 110a and 110b. CPU 110a is configured as a larger core CPU (also referred to as a big core) and CPU 110b is configured as a smaller core CPU (also referred to as a little core). In some embodiments, CPU 110a is faster than CPU 110b, but consumes more power.

In this embodiment of the camera control system 100b, large core CPU 110a is configured to execute the full 3A processing algorithm 305 and small core CPU 110b is configured to execute a lightweight version of the 3A processing algorithm 315. The complexity of the lightweight version 315 lies between the complexity of the full version 305 and the low power version 235 (which is still executed by the ISP 120). Also, in this embodiment, the scene change decision module 225 is configured to compare the quantified level of scene change to two threshold values to decide whether the scene change level (SCL) is high 325, medium 320, or low 330. For the case of a high SCL 325, full 3A processing 305 is performed by the large core CPU 110a. For the case of a medium SCL 320, lightweight 3A processing 315 is performed by the small core CPU 110b. For the case of a low SCL 330, low power 3A processing 235 is performed by the ISP 120. In some embodiments, the threshold values may be chosen empirically or user configurable.

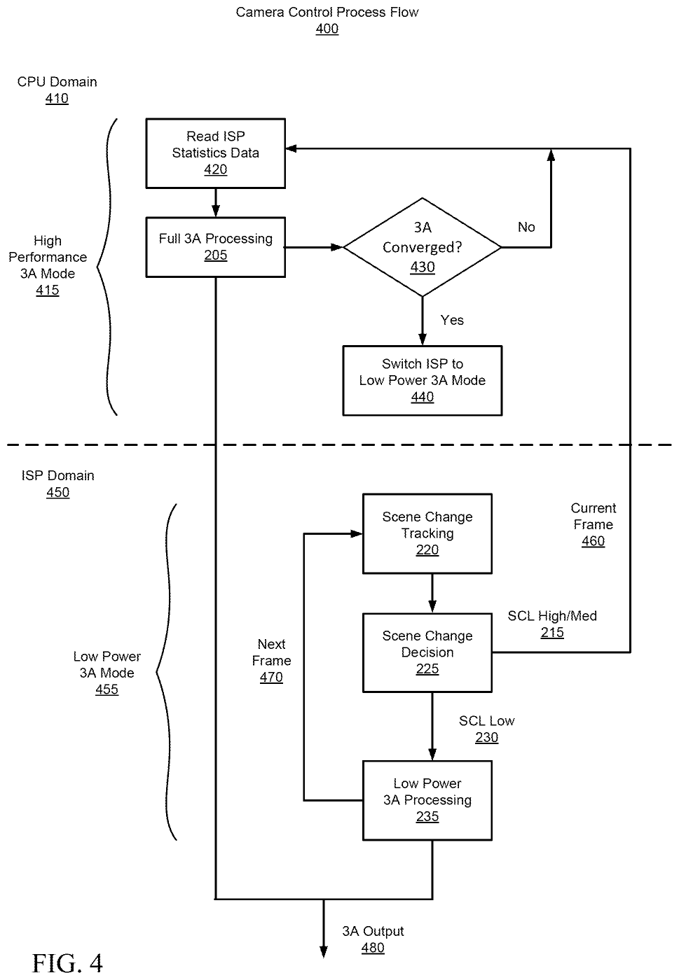

FIG. 4 is a flowchart illustrating a camera control process flow 400, in accordance with an embodiment of the present disclosure. The process comprises two domains: the CPU domain 410, which comprises the CPU software operations 200 to provide high performance 3A mode 415, and the ISP domain 450, which comprises the ISP software or firmware operation 210 to provide low power 3A mode 455. In the CPU domain 410, at operation 420, ISP statistics data is read. In some embodiments, the ISP may generate an interrupt or use other suitable signaling mechanisms to indicate that statistics data and a current image frame is available to the CPU. Full 3A processing 205 is then performed to provide 3A output 480. A determination is made, at operation 430, as to whether the 3A processing has converged to provide parameters that achieve desired levels of focus, exposure, white balance, etc. For example, an analysis of the sharpness of the image, using any suitable technique in light of the present disclosure, can determine whether or not focus has been achieved. If the 3A process has not yet converged, the CPU waits until the next interrupt and then the process loops on the next image frame. In some embodiments, full 3A processing 205 on the CPU is the default process for the first received image frame and continues until convergence is reached.

After determination that full 3A processing has reached convergence, the ISP is switched to low power 3A mode, at operation 440 and the CPU can enter a sleep or other low power state. In the ISP domain 450, when operating in low power 3A mode, a new frame 470 is received and processed by scene change tracker 220, as previously described. Scene change decision module then decides whether the SCL is high 215 (or medium in embodiment 100b) or low 230. If the SCL is high or medium, the image frame is passed back to the CPU as current frame 460 for full 3A processing. Otherwise, if the SCL is low, the ISP performs low power 3A processing 235 without waking the CPU, as previously described, to provide 3A output 480. The ISP then loops back for the next frame 470. In this manner, processing can switch back and forth between the CPU and ISP depending on the scene change level and the convergence of the full 3A processing.

### Methodology

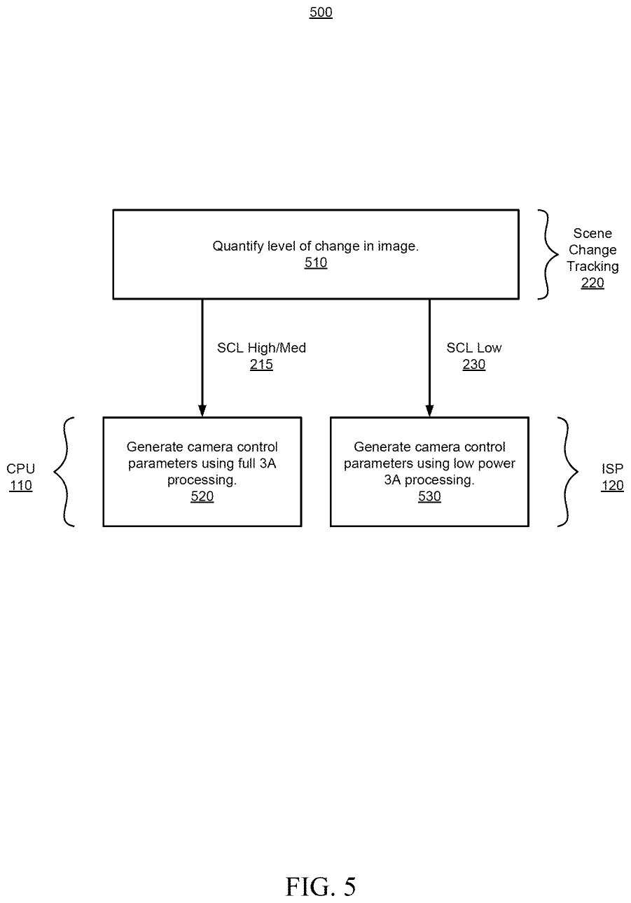

FIG. 5 is a flowchart illustrating a methodology 500 for camera control, in accordance with an embodiment of the present disclosure. As can be seen, the example method includes a number of phases and sub-processes, the sequence of which may vary from one embodiment to another. However, when considered in the aggregate, these phases and sub-processes form a process for reduced power control of camera parameters, in accordance with certain of the embodiments disclosed herein. These embodiments can be implemented, for example, using the system architecture illustrated in FIGS. 1-4, as described above. However other system architectures can be used in other embodiments, as will be apparent in light of this disclosure. To this end, the correlation of the various functions shown in FIG. 5 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 500. Thus, other embodiments may have fewer or more modules and/or sub-modules depending on the granularity of implementation. In still other embodiments, the methodology depicted can be implemented as a computer program product including one or more non-transitory machine-readable mediums that when executed by one or more processors cause the methodology to be carried out. Numerous variations and alternative configurations will be apparent in light of this disclosure.

As illustrated in FIG. 5, in an embodiment, method 500 for camera control commences by quantifying, at operation 510, a level of scene change between a current image frame provided by a camera and a previous image frame provided by the camera. In some embodiments, the quantification of the level of change may be based on one or more of motion estimation, detection of facial appearance, detection of facial disappearance, a time difference between acquisition of the current image frame and the previous image frame, accelerometer data provided by the camera, and gyroscope data provided by the camera.

Next, at operation 520, camera control parameters are generated using a first processing algorithm, based on the current and previous image frames, if the level of change exceeds a threshold. In some embodiments, the first processing algorithm is executed on CPU 110 and comprises a high complexity or “full” version of the algorithm. In some embodiments, the camera control parameters include auto-focus parameters, auto-exposure parameters, auto-whitebalance parameters, and video stabilization parameters.

Alternatively, at operation 530, the camera control parameters are generated using a second processing algorithm, based on the current and previous image frames, if the level of change does not exceed the threshold. In some embodiments, the second processing algorithm is executed on ISP 120 and comprises a lower complexity or “low power” version of the algorithm, which may provide results of sufficient quality given that the level of scene change between the image frames is relatively small. In some embodiments, the lower complexity version of the algorithm may be based on interpolation between the current image frame and the previous image frame.

By shifting workload to the ISP whenever possible, the CPU may be allowed to enter (or remain in) a power conserving sleep state for longer periods of time, reducing overall power consumption. Furthermore, in some embodiments, additional power savings may be realized as the ISP 120 may consume less power than the CPU 110, due in part to both the relatively simpler hardware of the ISP and the computationally simpler version of the algorithm executed by the ISP.

Of course, in some embodiments, additional operations may be performed, as previously described in connection with the system. For example, the system may comprise two CPUs: a large core CPU 110a and a small core CPU 110b, wherein the small core CPU consumes less power than the large core CPU. In these embodiments, the scene change level may be differentiated into three categories: high, medium, and low, each associated with a threshold value. Full processing may then be performed on the large core CPU for high level scene changes, low power processing may be performed on the ISP for low level scene changes, and lightweight processing may be performed on the small core CPU for medium level scene changes. In these embodiments, the computational complexity of lightweight processing falls between that of the full processing version and the low power processing version.

### Example System

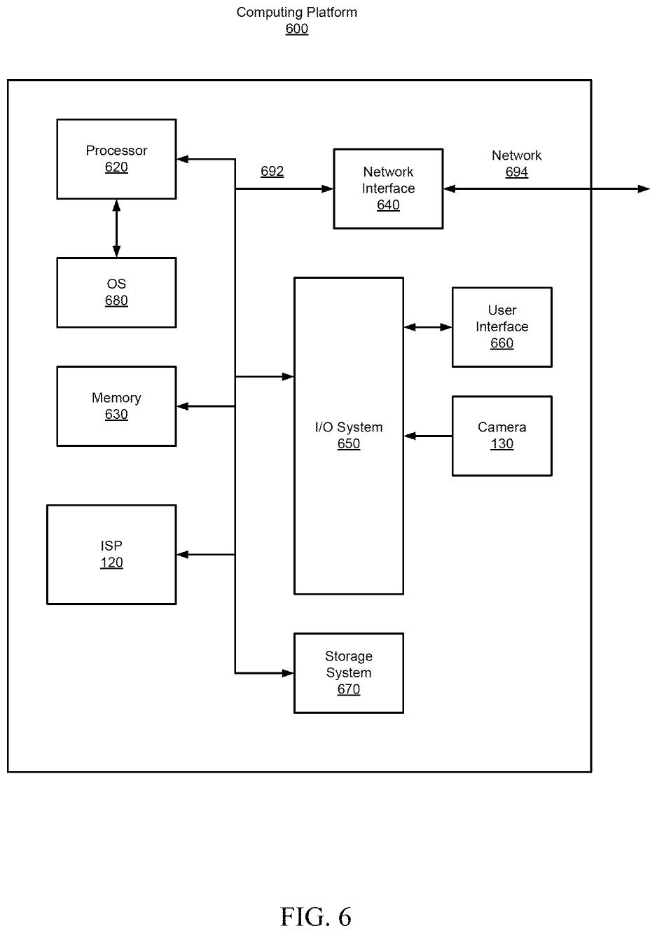

FIG. 6 is a block diagram schematically illustrating a computing platform 600 configured to perform reduced power camera control, in accordance with an embodiment of the present disclosure. In some embodiments, platform 600 may be hosted on, or otherwise incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone, smart-speaker, or smart-tablet), mobile internet device (MID), messaging device, data communication device, wearable device, embedded system, and so forth. Any combination of different devices may be used in certain embodiments.

In some embodiments, platform 600 may comprise any combination of a processor 620, a memory 630, an ISP 120, a network interface 640, an input/output (I/O) system 650, a user interface 660, a camera 130, and a storage system 670. As can be further seen, a bus and/or interconnect 692 is also provided to allow for communication between the various components listed above and/or other components not shown. Platform 600 can be coupled to a network 694 through network interface 640 to allow for communications with other computing devices, platforms, devices to be controlled, or other resources. Other componentry and functionality not reflected in the block diagram of FIG. 6 will be apparent in light of this disclosure, and it will be appreciated that other embodiments are not limited to any particular hardware configuration.

Processor 620 can be any suitable processor, and may include one or more coprocessors or controllers, such as an audio processor, a graphics processing unit, or hardware accelerator, to assist in control and processing operations associated with platform 600. In some embodiments, the processor 620 may be implemented as any number of processor cores, for example, a large core 110a and a small core 110b. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 620 may be implemented as a complex instruction set computer (CISC) or a reduced instruction set computer (RISC) processor. In some embodiments, processor 620 may be configured as an x86 instruction set compatible processor.

ISP 120 is a processor configured to perform image signal processing tasks that may be less complex than the tasks performed by processor 620. In some embodiments, ISP 120 may also be configured to consume less power than processor 620.

Memory 630 can be implemented using any suitable type of digital storage including, for example, flash memory and/or random-access memory (RAM). In some embodiments, the memory 630 may include various layers of memory hierarchy and/or memory caches as are known to those of skill in the art. Memory 630 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 670 may comprise technology to increase the storage performance enhanced protection for valuable digital media when multiple hard drives are included.

Processor 620 may be configured to execute an Operating System (OS) 680 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 600, and therefore may also be implemented using any suitable existing or subsequently-developed platform.

Network interface circuit 640 can be any appropriate network chip or chipset which allows for wired and/or wireless connection between other components of platform 600 and/or network 694, thereby enabling platform 600 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 650 may be configured to interface between various I/O devices and other components of platform 600. I/O devices may include, but not be limited to, user interface 660 and camera 130, which may be configured to provide images for camera control processing by processor 620 and ISP 120, as previously described. User interface 660 may include devices (not shown) such as a display element, microphone, touchpad, keyboard, and mouse, etc. I/O system 650 may include a graphics subsystem configured to perform processing of images for rendering on the display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 620 or any chipset of platform 600.

It will be appreciated that in some embodiments, the various components of platform 600 may be combined or integrated in a system-on-a-chip (SoC) architecture. In some embodiments, the components may be hardware components, firmware components, software components or any suitable combination of hardware, firmware or software. These components can be implemented or otherwise used in conjunction with a variety of suitable software and/or hardware that is coupled to or that otherwise forms a part of platform 600. These components can additionally or alternatively be implemented or otherwise used in conjunction with user I/O devices that are capable of providing information to, and receiving information and commands from, a user.

In various embodiments, platform 600 may be implemented as a wireless system, a wired system, or a combination of both. When implemented as a wireless system, platform 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 694. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 600 may comprise additional, fewer, or alternative subcomponents as compared to those included in the example embodiment of FIG. 6.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a camera control system, the system comprising: a scene change tracker to quantify a level of change between a current image frame provided by a camera and a previous image frame provided by the camera; a first processor to generate camera control parameters using a first processing algorithm, based on the current image frame and the previous image frame, if the level of change exceeds a first threshold; and a second processor to generate the camera control parameters using a second processing algorithm, based on the current image frame and the previous image frame, if the level of change does not exceed a second threshold, the second threshold less than or equal to the first threshold.

Example 2 includes the subject matter of Example 1, wherein the first processor is a general purpose processor, the second processor is an image signal processor that consumes less power than the general purpose processor, and the first processing algorithm is more computationally complex than the second processing algorithm.

Example 3 includes the subject matter of Examples 1 or 2, wherein the second processing algorithm is based on interpolation between the current image frame and the previous image frame.

Example 4 includes the subject matter of any of Examples 1-3, wherein the camera control parameters include auto-focus parameters, auto-exposure parameters, auto-whitebalance parameters, and video stabilization parameters.

Example 5 includes the subject matter of any of Examples 1-4, wherein the scene change tracker is to quantify the level of change between the current image frame and the previous image frame based on one or more of motion estimation, detection of facial appearance, detection of facial disappearance, a time difference between acquisition of the current image frame and the previous image frame, accelerometer data provided by the camera, and gyroscope data provided by the camera.

Example 6 includes the subject matter of any of Examples 1-5, further comprising a third processor to generate the camera control parameters using a third processing algorithm, based on the current image frame and the previous image frame, if the level of change exceeds the second threshold and does not exceed the first threshold.

Example 7 includes the subject matter of any of Examples 1-6, wherein the third processor is a general purpose processor that consumes less power than the first processor, and the third processing algorithm is less computationally complex than the first processing algorithm and more computationally complex than the second processing algorithm.

Example 8 includes the subject matter of any of Examples 1-7, wherein the scene change tracker executes on the second processor.

Example 9 is a processor-implemented method for camera control, the method comprising: quantifying, by a scene change tracker, a level of change between a current image frame provided by a camera and a previous image frame provided by the camera; generating, by a first processor-based system, camera control parameters using a first processing algorithm, based on the current image frame and the previous image frame, if the level of change exceeds a first threshold; and generating, by a second processor-based system, the camera control parameters using a second processing algorithm, based on the current image frame and the previous image frame, if the level of change does not exceed a second threshold, the second threshold less than or equal to the first threshold.

Example 10 includes the subject matter of Example 9, wherein the first processor-based system is a general purpose processor, the second processor based system is an image signal processor that consumes less power than the general purpose processor, and the first processing algorithm is more computationally complex than the second processing algorithm.

Example 11 includes the subject matter of Examples 9 or 10, wherein the second processing algorithm is based on interpolation between the current image frame and the previous image frame.

Example 12 includes the subject matter of any of Examples 9-11, wherein the camera control parameters include auto-focus parameters, auto-exposure parameters, auto-whitebalance parameters, and video stabilization parameters.

Example 13 includes the subject matter of any of Examples 9-12, further comprising quantifying the level of change between the current image frame and the previous image frame based on one or more of motion estimation, detection of facial appearance, detection of facial disappearance, a time difference between acquisition of the current image frame and the previous image frame, accelerometer data provided by the camera, and gyroscope data provided by the camera.

Example 14 includes the subject matter of any of Examples 9-13, further comprising generating, by a third processor-based system, the camera control parameters using a third processing algorithm, based on the current image frame and the previous image frame, if the level of change exceeds the second threshold and does not exceed the first threshold, wherein the third processor is a general purpose processor that consumes less power than the first processor, and the third processing algorithm is less computationally complex than the first processing algorithm and more computationally complex than the second processing algorithm.

Example 15 is at least one non-transitory machine-readable storage medium having instructions encoded thereon that, when executed by one or more processors, cause a process to be carried out for camera control, the process comprising: quantifying a level of change between a current image frame provided by a camera and a previous image frame provided by the camera; generating camera control parameters using a first processing algorithm, based on the current image frame and the previous image frame, if the level of change exceeds a first threshold; and generating the camera control parameters using a second processing algorithm, based on the current image frame and the previous image frame, if the level of change does not exceed a second threshold, the second threshold less than or equal to the first threshold.

Example 16 includes the subject matter of Example 15, wherein the first processing algorithm is more computationally complex than the second processing algorithm.

Example 17 includes the subject matter of Examples 15 or 16, wherein the second processing algorithm is based on interpolation between the current image frame and the previous image frame.

Example 18 includes the subject matter of any of Examples 15-17, wherein the camera control parameters include auto-focus parameters, auto-exposure parameters, auto-whitebalance parameters, and video stabilization parameters.

Example 19 includes the subject matter of any of Examples 15-18, wherein the process comprises quantifying the level of change between the current image frame and the previous image frame based on one or more of motion estimation, detection of facial appearance, detection of facial disappearance, a time difference between acquisition of the current image frame and the previous image frame, accelerometer data provided by the camera, and gyroscope data provided by the camera.

Example 20 includes the subject matter of any of Examples 15-19, wherein the process comprises generating the camera control parameters using a third processing algorithm, based on the current image frame and the previous image frame, if the level of change exceeds the second threshold and does not exceed the first threshold, wherein the third processing algorithm is less computationally complex than the first processing algorithm and more computationally complex than the second processing algorithm.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

1. A camera control system, the system comprising:
a scene change tracker to quantify a level of change between a current image frame provided by a camera and a previous image frame provided by the camera;
a first processor to generate camera control parameters using a first processing algorithm, based on the current image frame and the previous image frame, if the level of change exceeds a first threshold; and
a second processor to generate the camera control parameters using a second processing algorithm, based on the current image frame and the previous image frame, if the level of change does not exceed a second threshold, the second threshold less than or equal to the first threshold.

2. The system of claim 1, wherein the first processor is a general purpose processor, the second processor is an image signal processor that consumes less power than the general purpose processor, and the first processing algorithm is more computationally complex than the second processing algorithm.

3. The system of claim 1, wherein the second processing algorithm is based on interpolation between the current image frame and the previous image frame.

4. The system of claim 1, wherein the camera control parameters include auto-focus parameters, auto-exposure parameters, auto-whitebalance parameters, and video stabilization parameters.

5. The system of claim 1, wherein the scene change tracker is to quantify the level of change between the current image frame and the previous image frame based on one or more of motion estimation, detection of facial appearance, detection of facial disappearance, a time difference between acquisition of the current image frame and the previous image frame, accelerometer data provided by the camera, and gyroscope data provided by the camera.

6. The system of claim 1, further comprising a third processor to generate the camera control parameters using a third processing algorithm, based on the current image frame and the previous image frame, if the level of change exceeds the second threshold and does not exceed the first threshold.

7. The system of claim 6, wherein the third processor is a general purpose processor that consumes less power than the first processor, and the third processing algorithm is less computationally complex than the first processing algorithm and more computationally complex than the second processing algorithm.

8. The system of claim 1, wherein the scene change tracker executes on the second processor.

9. A processor-implemented method for camera control, the method comprising:
quantifying, by a scene change tracker, a level of change between a current image frame provided by a camera and a previous image frame provided by the camera;
generating, by a first processor-based system, camera control parameters using a first processing algorithm, based on the current image frame and the previous image frame, if the level of change exceeds a first threshold; and
generating, by a second processor-based system, the camera control parameters using a second processing algorithm, based on the current image frame and the previous image frame, if the level of change does not exceed a second threshold, the second threshold less than or equal to the first threshold.

10. The method of claim 9, wherein the first processor-based system is a general purpose processor, the second processor based system is an image signal processor that consumes less power than the general purpose processor, and the first processing algorithm is more computationally complex than the second processing algorithm.

11. The method of claim 9, wherein the second processing algorithm is based on interpolation between the current image frame and the previous image frame.

12. The method of claim 9, wherein the camera control parameters include auto-focus parameters, auto-exposure parameters, auto-whitebalance parameters, and video stabilization parameters.

13. The method of claim 9, wherein quantifying the level of change between the current image frame and the previous image frame is based on one or more of motion estimation, detection of facial appearance, detection of facial disappearance, a time difference between acquisition of the current image frame and the previous image frame, accelerometer data provided by the camera, and gyroscope data provided by the camera.

14. The method of claim 9, further comprising generating, by a third processor-based system, the camera control parameters using a third processing algorithm, based on the current image frame and the previous image frame, if the level of change exceeds the second threshold and does not exceed the first threshold, wherein the third processor is a general purpose processor that consumes less power than the first processor, and the third processing algorithm is less computationally complex than the first processing algorithm and more computationally complex than the second processing algorithm.

15. At least one non-transitory machine-readable storage medium having instructions encoded thereon that, when executed by one or more processors, cause a process to be carried out for camera control, the process comprising:
quantifying a level of change between a current image frame provided by a camera and a previous image frame provided by the camera;
generating camera control parameters using a first processing algorithm, based on the current image frame and the previous image frame, if the level of change exceeds a first threshold; and
generating the camera control parameters using a second processing algorithm, based on the current image frame and the previous image frame, if the level of change does not exceed a second threshold, the second threshold less than or equal to the first threshold.

16. The at least one computer readable storage medium of claim 15, wherein the first processing algorithm is more computationally complex than the second processing algorithm.

17. The at least one computer readable storage medium of claim 15, wherein the second processing algorithm is based on interpolation between the current image frame and the previous image frame.

18. The at least one computer readable storage medium of claim 15, wherein the camera control parameters include auto-focus parameters, auto-exposure parameters, auto-whitebalance parameters, and video stabilization parameters.

19. The at least one computer readable storage medium of claim 15, wherein quantifying the level of change between the current image frame and the previous image frame is based on one or more of motion estimation, detection of facial appearance, detection of facial disappearance, a time difference between acquisition of the current image frame and the previous image frame, accelerometer data provided by the camera, and gyroscope data provided by the camera.

20. The at least one computer readable storage medium of claim 15, wherein the process comprises generating the camera control parameters using a third processing algorithm, based on the current image frame and the previous image frame, if the level of change exceeds the second threshold and does not exceed the first threshold, wherein the third processing algorithm is less computationally complex than the first processing algorithm and more computationally complex than the second processing algorithm.
